(19) United States
(12) Patent Application Publication
(10) Pub. No.: US 2005/0130115 A1
(43) Pub. Date: Jun. 16, 2005

(54) Method for altering the gender ratio of offspring in mammals by manipulation of spermatozoa

(75) Inventors: Dennis A. Funk, Monona, WI (US); Stuart G. Revell, Ruthin (GB); Marvin M. Pace, DeForest, WI (US); Jeffery M. Betthauser, Windsor, WI (US); Marjorie A. Faust, Waunakee, WI (US)

Correspondence Address: MICHAEL BEST & FRIEDRICH, LLP, ONE SOUTH PINCKNEY STREET, P O BOX 1806, MADISON, WI, 53701, US

(73) Assignee: ABS Global,Inc., DeForest, WI (US)

(21) Appl. No.: 10/979,029

(22) Filed: Nov. 1, 2004

Related U.S. Application Data
(60) Provisional application No. 60/516,094, filed on Oct. 31, 2003.

(51) Int. Cl. A01N 1/02

(52) U.S. Cl. 435/2

(57) ABSTRACT

The present invention describes a methodology for exploiting differences in the aging rates of X- and Y-bearing spermatozoa to enable pre-selection of gender of offspring in mammals.

### CROSS-REFERENCE TO RELATED APPLICATIONS

This application claims the benefit of priority from U.S. Provisional Application No. 60/516,094, filed Oct. 31, 2003, incorporated herein by reference.

### STATEMENT REGARDING FEDERALLY SPONSORED RESEARCH OR DEVELOPMENT

Not Applicable

### FIELD OF THE INVENTION

This invention relates to a method of obtaining a sex skewed sample of spermatozoa. The concentration and/or separation of X- and Y-bearing sperm from semen samples would enhance the probability of obtaining one sex over the other through an artificial insemination or in vitro fertilization program by utilizing the proper semen fraction.

### BACKGROUND OF THE INVENTION

Under normal conditions of natural breeding and artificial insemination (AI), the gender ratio of the resulting offspring is approximately 50% male and 50% female. Farmers and other animal husbandry persons have long recognized the desirability of enhancing the probability of realizing offspring of a selected sex. Beyond obvious physiological aspects, the actual sex selection of mammalian offspring has significant economic consequences when one considers its application to food producing animals such as cattle and pigs as well as celebrated trophy and companion animals such as horses, dogs and the like. A variety of efforts have attempted to achieve sex-selected offspring. Those that appear most likely to achieve the desired results have been efforts at sorting and selecting between X and Y sperm prior to insemination.

In mammals, gender is determined by the sex chromosomes, X and Y. Diploid male cells possess both X and Y chromosomes; whereas cells in females contain only X chromosomes. Sperm which are haploid cells originate from the division of diploid male cells, consequently, sperm possess an X or Y chromosome and ultimately determine the gender of resulting offspring. Further, X- and Y-bearing sperm normally are produced in equal proportions, because the diploid cells from which they originate possess one X and one Y chromosome.

Many methods have been reported to achieve the separation of X- and Y-chromosome bearing sperm. These methods have ranged from magnetic techniques, such as appears disclosed in U.S. Pat. No. 4,276,139, to columnar techniques as appears disclosed in U.S. Pat. No. 5,514,537, to gravimetric techniques as discussed in U.S. Pat. Nos. 3,894,529, U.S. reissue Pat. No. 32350, U.S. Pat. Nos. 4,092,229, 4,067,965, and 4,155,831. Use of electrical properties has also been attempted as shown in U.S. Pat. No. 4,083,957 as well as a combination of electrical and gravimetric properties as discussed in U.S. Pat. Nos. 4,225,405, 4,698,142, and 4,749,458. Use of motility properties has also been attempted as shown in U.S. Pat. Nos. 4,009,260 and 4,339,434. Chemical techniques have also been disclosed, such as those shown in U.S. Pat. Nos. 4,511,661 and 4,999,283 (involving monoclonal antibodies) and U.S. Pat. Nos. 5,021,244, 5,346,990, 5,439,362, and 5,660,997 (involving membrane proteins), and U.S. Pat. Nos. 3,687,803, 4,191,749, 4,448,767, and 4,680,258 (involving antibodies) as well as the addition of serum components as shown in U.S. Pat. No. 4,085,205.

Another known methodology for sorting sperm uses a quantitative difference in the DNA content of X and Y chromosomes and consequently in the DNA content of X- and Y-bearing sperm. U.S. Pat. No. 5,135,759 issued to Johnson involves individual discrimination and separation of the sperm through the techniques of flow cytometry.

No successful method has been devised for differentiating spermatozoa based on a qualitative measure (for a review, see Seidel and Garner. Reproduction. 2002. 124:733-743, incorporated herein by reference).

### SUMMARY OF THE INVENTION

The present invention describes a methodology for exploiting differences in the aging rates of X- and Y-bearing spermatozoa to enable pre-selection of gender of offspring in mammals. As spermatazoa age, the sperm can undergo capacitation, the acrosome reaction, membrane changes and various physiological changes. As X- and Y-bearing sperm age, they undergo various process, such as capacitation and the acrosome reaction at different rates. Aging conditions of sperm can be used to skew the resulting sex ratio of offspring. By manipulating the time and physical conditions (such as medium content and temperature) that sperm are subjected to after ejaculation, deviation from equal proportions of X- and Y-bearing sperm can be skewed. When it is desired to separate distinct X and Y rich fractions, various methods may be used, including separation based on differential sugar affinities expressed by capacitated, acrosome reacted spermatozoa and non-capacitated sperm, Sephadex™ and glass wool filtering, or Optiprep™ and other centrifugation gradients to separate live and dead populations.

In one aspect the present invention provides a method of obtaining a semen sample composition where more than 50% of the live sperm in the sample are X chromosome bearing. The method includes adding a semen sample to a first dilution solution to obtain a semen sample composition. Optionally, further dilution agents can be added. The composition can either be rested at this point, or can be put through a washing stage to aid in the removal of seminal fluids. If washed, the semen sample composition is suitably mixed with a wash solution and centrifuged to obtain a supernatant. The supernatant is then decanted and a second dilution solution is added to the semen sample composition. Suitably, enough dilution solution is added to bring the volume of the semen sample composition back to the same or similar volume as was originally obtained when the original dilution solution was added.

After the first or second dilution solution (and any optional dilution agents) is added, the semen sample composition is allowed to rest. Suitably, the semen sample composition is allowed to rest from 1 minute to 48 hours at a temperature between 0-45° C., more suitably 37-39° C. The semen sample composition suitably can be rested in an atmosphere containing up to 10% carbon dioxide, and more suitably in an atmosphere containing 5% carbon dioxide.

At the end of the resting period, the semen sample composition contains a live fraction of sperm that contains more than 50% X chromosome bearing sperm.

In another embodiment, the method comprises obtaining a semen sample and putting it through the washing stage to remove seminal fluids first. A washing solution is added to the semen sample and centrifuged to obtain a supernatant. The supernatant is decanted and a first dilution solution is then added to the semen sample to obtain a semen sample composition. The semen sample is then rested. Suitably, the semen sample composition is allowed to rest from 1 minute to 48 hours at a temperature between 0-45° C., more suitably 37-39° C. The semen sample composition suitably can be rested in an atmosphere containing up to 10% carbon dioxide, and more suitably in an atmosphere containing 5% carbon dioxide.

At the end of the resting period, the semen sample composition contains a live fraction of sperm that contains more than 50% X chromosome bearing sperm.

To aid in increasing the percentage of X chromosome bearing sperm, the semen sample composition can optionally be frozen or vitrified after the resting period. After thawing the frozen or vitrified semen sample composition, a greater fraction of live sperm containing the X chromosome is found in the sample.

The method is based on qualitative measures of physiological activity resulting from differential aging of X- and Y-bearing sperm. The present invention provides that aging conditions can be optimized such that the deviation from equal proportions of X- and Y-bearing capacitated sperm is maximized.

A fuller appreciation of specific adaptations, compositional variations, and physical attributes will be gained upon an examination of the following detailed description of preferred embodiments, taken in conjunction with the appended claims.

Before the embodiments of the invention are explained in detail, it is to be understood that the phraseology and terminology used herein are for the purpose of description and should not be regarded as limiting. The use of “including”, “having” and “comprising” and variations thereof herein is meant to encompass the items listed thereafter and equivalents thereof as well as additional items and equivalents thereof.

### DETAILED DESCRIPTION OF THE INVENTION

The present invention provides a methodology for exploiting differences in aging rates of X- and Y-bearing spermatozoa to enable pre-selection of gender of offspring in mammals. This methodology allows for a high likelihood for realizing offspring of the desired sex at a lower cost and with higher rates of pregnancy per dose of sperm as compared to other available methodologies.

Mammalian sperm produced by the testes undergo several maturation changes to achieve full maturity and competency for fertilizing ova. One important change that sperm must undergo is the multi-step process termed “capacitation” which encompasses several biochemical and ultrastructural changes in the sperm plasma membrane. Ultimately, the process of capacitation renders sperm capable of interaction with oocytes and engaging the acrosome reaction. The acrosome reaction is a process thought to be marked by the progressive breakdown of the outer acrosomal membrane and fusion of the resulting membrane vesicles with the sperm plasma membrane. Physiologically, sperm capacitation and the acrosome reaction are important to enable successful fertilization of ova; however, premature aging can lead to early death of spermatozoa. When capacitation proceeds more rapidly in one sperm type, enhancing the capacitation process prior to insemination makes it more likely that cells of this more rapidly capacitating type will die before fertilization can occur. This scenario will result in a skewing of the sex of offspring towards the later capacitating sperm type.

The process of capacitation proceeds at different rates in X- and Y-bearing spermatozoa. Specifically, Y-bearing sperm capacitate more rapidly after ejaculation than do X-bearing sperm. Optimizing the control of capacitation and the acrosome reaction can maximize the likelihood for realizing offspring of the desired sex. Capacitated sperm fractions will be rich in live Y-bearing sperm cells; conversely, non-capacitated fractions will be rich in live X-bearing cells. Slight exposure of sperm cells to conditions that promote capacitation will yield either equal proportions of male and female offspring or proportions that slightly favor male calves. However, significantly accelerated or enhanced capacitation will yield more female calves. This provides to the individual carrying out artificial insemination a high likelihood for realizing offspring of the desired sex. This method of producing a sex skewed semen sample is of great benefit over current methods as no physical or mechanical sorting of sperm is required. Such methods, including flow cytometry and various other assays using fluorescent compositions can lead to damage of the sperm itself in the sorting process.

As used herein, the term “semen sample” means spermatozoa and any other seminal fluid which is discharged from the animal in the ejaculate.

The term “dilution solution” includes any composition which modifies sperm cell membranes or their physiological function. Suitable dilution solutions can include the agents Tyrode's medium with albumin (TALP); Dulbecco's phosphate buffered saline (D-PBS); Biggers, Whitten and Whittingham medium, phosphate buffered saline (PBS); 2-amino-2-(hydroxymethyl)-1,3-propanediol (Tris); N-tris(hydroxymethyl)methyl-2-aminoethanesulphonic acid (Tes); a combination of Tris and Tes (TEST); 4-(2-hydroxyethyl)piperazine-1-ethanesulphonic acid (Hepes); ionophores; steroid hormones including progesterone and estradiol; heparin; membrane composition modifiers including cholesterol, cyclodextrin, liposomes and detergents; pH modifiers; amino acids, including basic amino acids such as lysine, arginine and histidine; gamma aminobutyric acid; egg yolks and modified egg yolks from chickens and other avian species including those enhanced with omega-3 fatty acids; other egg constituents, viscosity altering agents including iodixanol, bovine serum albumin; polyvinyl alcohol; seminal plasma including seminal plasma protein; follicular fluid; zona pellucida glycoprotein; and antibodies. An example of one embodiment of a dilution solution is shown in Table 1.

TABLE 1

| Ingredient | Concentration | | Qty | |
|---|---|---|---|---|
| Heparin | 10 | μg/ml | 0.01 | g |
| NaCl | 99 | mM | 5.786 | g |
| KCl | 3.1 | mM | 0.231 | g |
| NaHCO₃ | 25 | mM | 2.1 | g |
| NaH₂PO₄ | 0.35 | mM | 0.042 | g |
| HEPES | 10 | mM | 2.383 | g |
| CaCl₂ | 2 | mM | 0.294 | g |
| MgCl₂ | 1.1 | mM | 0.105 | g |
| Na Lactate | 1.1 | mg/ml | 1.1 | g |
| Bovine Serum Albumin | 6 | mg/ml | 6.0 | g |
| Gentamicin (25 μl of | 1 | μg/ml | 1 | mg |
| 40 mg/ml sol'n) | | | | |

The general methodology of one embodiment of the invention is as follows. A semen sample is collected from a mammal. The methodology of the invention is suitably optimized for bovines, but can be utilized with other mammals. A dilution solution is added to the semen sample to obtain a semen sample composition. Suitably, an amount of dilution solution is utilized so that the semen sample is diluted to a concentration of 2 million or greater sperm per milliliter of sperm sample composition (combination of semen sample/dilution solution/optional agents. The semen sample composition at this point can either be rested or washed.

If washed, a washing agent is added to the semen sample composition to obtain a wash composition. Such washing agents include dilution solutions. Suitably, such compositions include D-PBS, D-PBS with calcium and magnesium, and other cell culture media. The volume of wash solution required is that amount necessary to significantly remove or separate seminal plasma from sperm cells, for example, a volume of wash solution that is at least two times the volume of semen. The washed composition is then placed in a centrifuge. Suitably, the centrifuge is spun at 900 g for 10 minutes. The supernatant of the washed composition is then decanted. This washing step can suitably be done one to five times. Once the washing phase is completed, a dilution solution is added to the semen sample composition. Suitably, enough dilution solution is added to bring the volume of the semen sample composition back to the same or similar volume as was originally obtained when the initial dilution solution was added to the semen sample.

After the dilution solution (and any optional dilution agents) is added to the semen sample composition, and after the washing step if performed, the semen sample composition is allowed to rest. Suitably the semen sample composition is allowed to rest between one minute to 48 hours at a temperature between 0-45° C., more suitably 37-39° C. The semen sample suitably can be rested in an atmosphere containing up to 10% carbon dioxide, and more suitably in an atmosphere containing 5% carbon dioxide.

After the resting period is over, the semen sample composition contains a live fraction of sperm that contains more than 50% X chromosome bearing sperm.

In another embodiment of the method of the invention, the semen sample is put through the washing step before the dilution solution is added to the semen sample. After washing, the dilution solution is added to the semen sample to form the semen sample composition. The semen sample composition can then be rested in suitable conditions.

To aid in increasing the percentage of X chromosome bearing sperm, the semen sample composition can optionally be frozen or vitrified after the resting period. These freezing methods include any standard methods used for freezing semen used for insemination or IVF embryo production. After thawing the semen sample composition contains a greater fraction of live sperm containing the X chromosome.

### EXAMPLES

### Example 1

### Separation of Bovine X and Y Sperm Based on Surface Differences

Using a technique known as “cell surface chromatography,” set forth in Cartwright et al. (Molecular Reproduction and Development, 1993, 34:323-328) (incorporated herein by reference) live bovine spermatozoa were partitioned into two fractions on the basis of the hydrophobicity of their cell surfaces. One fraction consisted of a less hydrophobic group, and contained 32% of sperm of the original sample. The other fraction consisted of the more hydrophobic group and contained 68% of the original sample. 80% of the sperm in the less hydrophobic fraction were Y-bearing spermatozoa, while the remaining 20% were X-bearing. In the more hydrophobic fraction, 37% of the sperm were Y-bearing, while 63% of the sperm were X bearing. 40% of sperm in the less hydrophobic fraction had undergone the acrosome reaction, while no significant portion of sperm in the more hydrophobic fraction were acrosome-reacted.

Thus, at the time of separation, 51.2% of Y-bearing spermatozoa had capacitated, whereas, only 12.8% of X-bearing spermatozoa had undergone significant capacitation. For the non-capacitated group, 63% of spermatozoa were X-bearing.

### Example 2

### Gender Pre-Selection With Sperm Separation

Live spermatozoa are collected, and the samples are subjected for varying times to conditions that promote, capacitation. For bovine sperm, suitable promotion conditions comprise incubating the sperm in TALP or Dulbecco's saline at 39° C. in 5% CO2 in air, or in TEST extender. After exposure to capacitation-promoting conditions for varying times, sperm will be separated into non-capacitated and significantly more capacitated groups, and consequently into distinct X and Y rich fractions. One separation method may be based on the hydrophobicity of their cell surfaces as described in Example 1. Another method that may be used for separating sperm is based on the affinities of capacitated, acrosome reacted and non-capacitated sperm for individual sugar molecules. Adsorption columns are prepared in which the matrix will express either fucose or mannose on its surface. The incubated semen is passed through one of these columns. A fucose-expressing column will bind and retain non-capacitated sperm, while capacitated sperm will pass through and can be further processed for IVF or AI use. Such a fraction will tend to be rich in Y-bearing sperm. Semen passed through a mannose-expressing column will retain capacitated sperm, allowing non-capacitated to pass through and be gathered for further processing. Such a fraction will be expected to contain more X-bearing sperm.

### Example 3

### Gender Pre-Selection Without Sperm Separation

Live bovine spermatozoa are collected, and the sperm are subjected to conditions that promote capacitation and are well known in the art. For example, sperm are diluted in TALP or Dulbecco's saline at 39° C. in 5% CO₂ in air, or in TEST. Sperm samples are taken after exposure to the capacitation-promoting conditions for varying times, and used fresh for insemination or in vitro fertilization, or processed and frozen using methods well known in the art.

As a result of differences in rates of capacitation for X- and Y-bearing sperm, greater proportions of viable, capacitated sperm will be Y-bearing initially. As capacitation continues, a majority of X-bearing sperm will initiate then undergo capacitation. After ample time of exposure to conditions that promote capacitation, the Y-bearing sperm that first underwent capacitation will begin to die; consequently in sperm samples taken at these later time points, the majority of viable sperm are expected to be X-bearing.

When capacitation proceeds for short time periods (e.g. semen aged for <6 hours), 50-55% female fetuses are expected when such samples are used in AI. When capacitation proceeds for intermediate time periods (e.g. semen aged for ˜6 to 16 hours), 55-65% female fetuses are expected when such samples are used in AI. When capacitation continues for extended periods of time (e.g. semen aged for >16 hours), extremely low conception rates are expected using such samples, because a majority of sperm in these samples are expected to be dead.

### Example 4

### Separation of Dead and Acrosome Reacted Sperm

Ejaculate from one bull was diluted in TALP (pH 7.4, 290 mOsm/kg) to yield 60 million cells per ml and incubated for 5 hours at 39° C. on 5% CO₂ in air to promote capacitation. After incubation, the sample was mixed and 1 ml removed, placed on top of Sephadex™ G25 and glass wool (0.22 μm fibers) for filtration to remove dead and acrosome reacted sperm. After the semen sample had soaked into the filter bed, 2 ml of a commercial extender were layered on top of the filter bed and the entire filter assembly centrifuged at 50×g for 5 minutes to accelerate the filtration process. Sperm in the filtrate were taken and subjected to Fluorescence in-situ hybridization (FISH) according to the method set forth in Rens et al., “An X-Y paint set and sperm FISH protocol that can be used for validation of cattle sperm separation procedures”, Reproduction, 2001, 121:541-546 (incorporated herein by reference) to differentiate X- and Y-bearing cells. A count of 800 filtered sperm determined that 55.3% were X-bearing, and suggested that the retained dead and acrosome reacted sperm fraction was comprised of a majority of Y-bearing cells.

### Example 5

### Sex Skew of Sample By Time of Incubation

An ejaculate was collected from a Charolais bull and diluted to 4 million sperm/ml in TALP supplemented with heparin (10 μg/ml TALP). To obtain a high proportion of live sperm, the sample was filtered. For filtration, 2×10 ml vectaspin tubes were used. These have a filter insert with a capacity of 3 mls and a 10 μm polypropylene mesh filter. Above the mesh, additional filtration was prepared by adding a depth of glass wool and on top of this a layer of Sephadex™ G25. A volume of 10 mls semen diluted in TALP was placed on top of the filter and allowed to settle before the filter was flushed with a further 10 mls of TALP. The contents of the two filtrates were pooled and the resulting sample was incubated at 37° C. in 5% CO₂ over a period of 4 hours.

FISH results from the samples are shown in the table 2 below:

TABLE 2
Sex chromosome results for control and treated spermatozoa samples.

| | Sex Chromosome Labeled Spermatozoa | | |
|---|---|---|---|
| Sample | Y-bearing | X-bearing | No. evaluated |
| Control | 50.0 | 50.0 | 200 |
| Treated | 43.6 | 56.4 | 500 |

The FISH results show an increase in the proportion of X-bearing sperm in the treated sample.

### Example 6

### Viability of Sperm Frozen in Capacitating Conditions

A single ejaculate was collected from a Friesian bull and diluted to 280 million sperm cells/ml in TALP supplemented with heparin (10 μg/ml of TALP). The diluted sperm sample was incubated immediately at 37° C. under 5% CO₂ for 4 hours. After the 4 hours of incubation, 15 ml of the sample was filtered through a Sephadex™/glass wool filter to remove the dead. An aliquot of the filtrate (live) was taken for FISH. The live filtrate was washed out of the TALP by centrifuging (800 g for 20 minutes) the sperm suspension over a 1.12 g/ml OptiPrep™/EquiPrep™ underlay and the sperm recovered. The sample was then diluted in Tris, packed in 0.25 ml straws and frozen using a commercial freezing protocol well known in the art. The aliquots taken at the start of the experiment (control) and that from the live filtrate following 4 hour incubation were subjected to FISH. Post-thaw an OptiPrep™ gradient was used to separate live sperm post-thaw and the live and “total” processed sperm were then subjected to FISH.

The results from FISH are shown below in table 3

TABLE 3
Sex chromosome and viability results for
control and treated spermatozoa samples.

| | | Sex Chromosome Labeled Spermatozoa | | |
|---|---|---|---|---|
| Sample | Live, % | Y-bearing | X-bearing | No. evaluated |
| Pre-freeze | | | | |
| Control | 89.0 | 49.5 | 50.5 | 400 |
| Treated | 76.0 | 47.5 | 52.5 | 400 |
| Post-thaw | | | | |
| Control | | 45.5 | 54.5 | 400 |
| Treated | 64.5 | 42.0 | 58.0 | 400 |

Results illustrate that the incubation process yielded a sample with a larger proportion of live X-bearing sperm than the control sample in both fresh (pre-freeze) and frozen-thawed fractions.

### Example 7

### 4-hr. Incubation With TALP and Heparin

Semen was collected from a Limousin bull. One aliquot was diluted in TALP supplemented with heparin (1 ml of raw semen: 4 ml TALP). The second aliquot was set aside as a control for Fluorescence in situ hybridization (FISH) to determine ratios of X- and Y-bearing spermatozoa. The TALP diluted sample was further diluted with TALP to 10 million sperm cells/ml and incubated under 5% CO2 at 39° C. over a 4 hour period. For assessment only, live and dead sperm were separated using OptiPrep™ gradients. Sex chromosome and viability results for control and treated samples are in table 4.

TABLE 4
Sex chromosome and viability results for
control and treated spermatozoa samples.

| | | Sex Chromosome Labeled Spermatozoa | | |
|---|---|---|---|---|
| Sample | Live, % | Y-bearing | X-bearing | No. evaluated |
| Control | 93.0 | 51.3 | 48.7 | 300 |
| Treated | 89.6 | | | |
| Dead | | 53.5 | 46.5 | 800 |
| Live | | 49.0 | 51.0 | 400 |

Results demonstrate that the incubation process successfully shifted the ratio of Y-bearing spermatozoa in the live and dead fractions, and consequently yielded a sample with a larger proportion of live X-bearing sperm than the control sample.

### Example 8

### Incubation Alone Versus Incubation Following Removal of Seminal Plasma

Semen was collected from a Friesian bull. An initial aliquot was set aside as a control for Fluorescence in situ hybridization (FISH) to determine ratios of X- and Y-bearing spermatozoa. One aliquot was diluted in TALP supplemented with heparin to a concentration of 10 million sperm cells/ml. Another aliquot was centrifuged (800 g for 10 minutes) over 1.0809 g.ml of OptiPrep™/Eqsellsire™ to remove seminal plasma. Following centrifugation, the supernatant was removed and the washed sample was resuspended in TALP supplemented with heparin to a concentration of 10 million sperm cells/ml. The two TALP treatment samples were then incubated under 5% CO2 at 39° C. over a 4 hour period. For assessment only, live and dead sperm were separated using OptiPrep™ gradients. Sex chromosome and viability results for control and treated samples are in table 5.

TABLE 5
Sex chromosome and viability results for
control and two treated spermatozoa samples.

| | | Sex Chromosome Labeled Spermatozoa | | |
|---|---|---|---|---|
| Sample | Live, % | Y-bearing | X-bearing | No. evaluated |
| Control | 91.4 | 50.2 | 49.8 | 400 |
| Treated | 80.8 | | | |
| Dead | | 57.2 | 42.8 | 500 |
| Live | | 46.6 | 53.4 | 600 |
| Treated, seminal | 79.0 | | | |
| plasma removed | | | | |
| Dead | | 56.1 | 43.9 | 700 |
| Live | | 44.8 | 55.2 | 700 |

Results demonstrate that the incubation process successfully shifted the ratio of X-bearing spermatozoa in the live and dead fractions, and consequently yielded treated samples with a larger proportion of live X-bearing sperm than the control sample. The shift towards more live X-bearing spermatozoa was more pronounced in the sample for which seminal plasma had been removed prior to further processing.

### Example 9

### Incubation in TALP-PVA followed by Commercial Packaging and Freezing

Semen was collected from a Holstein bull. One aliquot was diluted in TALP where 1 g/L Polyvinyl alcohol (PVA) substituted for bovine serum albumin. The second aliquot was set aside as a control for Fluorescence in situ hybridization (FISH) to determine ratios of X- and Y-bearing spermatozoa. The TALP-PVA diluted sample was then incubated under 5% CO2 at 39° C. over a 6 hour period. For assessment only, live and dead sperm were separated using Sephadex™ G25/glass wool filtering to remove the dead fraction. Sperm in the filtrate were concentrated by centrifugation and the supernatant removed. This sample was further diluted for packaging and freezing by a commercial semen extender to achieve a final concentration of 5×10⁶ sperm/0.5 ml straw. Sex chromosome and viability results for control and treated samples are in table 6.

TABLE 6
Sex chromosome and viability results for
control and two treated spermatozoa samples.

| | | Sex Chromosome Labeled Spermatozoa | | |
|---|---|---|---|---|
| Sample | Live, % | Y-bearing | X-bearing | No. evaluated |
| Control | | | | |
| Pre-freeze | 94.2 | 51.0 | 49.0 | 100 |
| Post-thaw | 66.0 | 52.0 | 48.0 | 100 |
| Treated | | | | |
| Post-thaw | | | | |
| Dead | | 53.2 | 46.8 | 500 |
| Live | | 44.4 | 55.6 | 500 |

Results demonstrate that the incubation process successfully shifted the ratio of X-bearing spermatozoa in the live and dead fractions, and consequently yielded treated frozen-thawed samples with a larger proportion of live X-bearing sperm than the control sample.

While the present invention has now been described and exemplified with some specificity, those skilled in the art will appreciate the various modifications, including variations, additions, and omissions that may be made in what has been described. Accordingly, it is intended that these modifications also be encompassed by the present invention and that the scope of the present invention be limited solely by the broadest interpretation lawfully accorded the appended claims.

All patents, publications and references cited herein are hereby fully incorporated by reference. In case of conflict between the present disclosure and incorporated patents, publications and references, the present disclosure should control.

1. A method of obtaining a semen sample composition where more than 50% of live sperm in the sample are X chromosome bearing, comprising
a) adding a first dilution solution to a bovine semen sample to obtain a semen sample composition; and
b) allowing the semen sample composition to rest between 1 minute to 48 hours, at a temperature of between 0-45° C.

2. The method of claim 1 wherein the first dilution solution is added in an amount to dilute the semen sample to a concentration of 2 million or greater sperm per milliliter of sperm sample composition.

3. The method of claim 1 wherein the first dilution solution is added to the sperm sample in a ratio of 2:1 by volume.

4. The method of claim 1 wherein the first dilution solution comprises an agent selected from the group consisting of Tyrode's medium with albumin (TALP), Dulbecco's phosphate buffered saline (D-PBS), Biggers Whitten and Whittingham medium, phosphate buffered saline (PBS), 2-amino-2-(hydroxymethyl)-1,3-propanediol (Tris), N-tris(hydroxymethyl)methyl-2-aminoethanesulphonic acid (Tes), a combination of Tris and Tes (TEST), 4-(2-hydroxyethyl)piperazine-1-ethanesulphonic acid (Hepes), an ionophore, a steroid hormones, heparin, a membrane composition modifier, a pH modifier, an amino acid, gamma aminobutyric acid, an egg yolk, a modified egg yolk, an egg constituent, a viscosity altering agent; seminal plasma; follicular fluid; and zona pellucida glycoprotein.

5. The method of claim 1, after step a), further comprising the following steps:
i) washing the semen sample composition by centrifugation to obtain supernatant;
ii) decanting supernatant from the semen sample composition; and
iii) adding a second dilution solution to the semen sample composition.

6. The method of claim 4 wherein the agent is TALP.

7. The method of claim 4 wherein the agent is D-PBS.

8. The method of claim 4 wherein the agent is PBS.

9. The method of claim 4 wherein the agent is Tris.

10. The method of claim 4 wherein the agent is Tes.

11. The method of claim 4 wherein the agent is TEST.

12. The method of claim 4 wherein the first agent is Hepes.

13. The method of claim 4 wherein the agent is a steroid hormone, wherein the steroid hormone is selected from the group consisting of progesterone and estradiol.

14. The method of claim 4 wherein the agent is a membrane composition modifier, wherein the membrane composition modifier is selected from the group consisting of cholesterol, cyclodextrin, a liposome and a detergent.

15. The method of claim 4 wherein agent is an amino acid, wherein the amino acid is a basic amino acid.

16. The method of claim 15 wherein the basic amino acid is selected from the group consisting of lysine, arginine and histidine.

17. The method of claim 4 wherein the agent is gamma aminobutyric acid (GABA).

18. The method of claim 4 wherein agent is a modified egg yolk, wherein the modified egg yolk is enhanced with omega-3 fatty acids.

19. The method of claim 4 wherein agent is a viscosity altering agent, wherein the viscosity altering agent is selected from the group consisting of iodixanol, bovine serum albumin, and polyvinyl alcohol.

20. The method of claim 1 wherein the composition of step b) is resting in an atmosphere containing up to 10% carbon dioxide.

21. The method of claim 1 wherein the composition in step b) is rested no more than four hours.

22. The method of claim 1 further comprising the steps:
c) freezing the sperm sample composition after it has gone through the resting step b) to create a frozen sperm sample composition; and
d) thawing the sperm sample composition.

23. The method of claim 1 further comprising the steps:
c) vitrifying the sperm sample composition after it has gone through the resting step b) to create a vitrified sperm sample composition; and
d) thawing the sperm sample composition.

24. The method of claim 22 wherein at least 58% of live sperm in the sample are X chromosome bearing

25. The method of claim 1 wherein the temperature is 39° C.

26. The method of claim 20 wherein the atmosphere contains 5% carbon dioxide.

27. A method of obtaining a semen sample composition where more than 50% of live sperm in the sample are X chromosome bearing, comprising
a) adding a first dilution solution to a semen sample to get a semen sample composition;
b) washing the semen sample composition by centrifugation to obtain supernatant;
c) decanting supernatant;
d) adding a second dilution solution to the semen sample composition; and
e) allowing the semen sample composition to rest between 1 minute to 48 hours, at a temperature of between 0-45° C., after the second dilution solution is added.

28. The method of claim 27 wherein the first dilution solution comprises an agent selected from the group consisting of Tyrode's medium with albumin (TALP), Dulbecco's phosphate buffered saline (D-PBS), Biggers Whitten and Whittingham medium, phosphate buffered saline (PBS), 2-amino-2-(hydroxymethyl)-1,3-propanediol (Tris), N-tris(hydroxymethyl)methyl-2-aminoethanesulphonic acid (Tes), a combination of Tris and Tes (TEST), 4-(2-hydroxyethyl)piperazine-1-ethanesulphonic acid (Hepes), an ionophore, a steroid hormones, heparin, a membrane composition modifier, a pH modifier, an amino acid, gamma aminobutyric acid, an egg yolk, a modified egg yolk, an egg constituent, a viscosity altering agent; seminal plasma; follicular fluid; and zona pellucida glycoprotein.

29. The method of claim 27 wherein the agent is TALP.

30. The method of claim 27 wherein the agent is D-PBS.

31. The method of claim 27 wherein the agent is PBS.

32. The method of claim 27 wherein the agent is Tris.

33. The method of claim 27 wherein the agent is Tes.

34. The method of claim 27 wherein the agent is TEST.

35. The method of claim 27 wherein the first agent is Hepes.

36. The method of claim 27 wherein the agent is a steroid hormone, wherein the steroid hormone is selected from the group consisting of progesterone and estradiol.

37. The method of claim 27 wherein the agent is a membrane composition modifier, wherein the membrane composition modifier is selected from the group consisting of cholesterol, cyclodextrin, a liposome and a detergent.

38. The method of claim 27 wherein agent is an amino acid, wherein the amino acid is a basic amino acid.

39. The method of claim 38 wherein the basic amino acid is selected from the group consisting of lysine, arginine and histidine.

40. The method of claim 27 wherein the agent is gamma aminobutyric acid (GABA).

41. The method of claim 27 wherein agent is a modified egg yolk, wherein the modified egg yolk is enhanced with omega-3 fatty acids.

42. The method of claim 27 wherein agent is a viscosity altering agent, wherein the viscosity altering agent is selected from the group consisting of iodixanol, bovine serum albumin, and polyvinyl alcohol.

43. The method of claim 27 wherein the composition of step e) is resting in an atmosphere containing up to 10% carbon dioxide.

44. The method of claim 43 wherein the atmosphere contains 5% carbon dioxide.

45. The method of claim 27 wherein the composition in step e) is rested no more than four hours.

46. The method of claim 27 further comprising the steps:
f) freezing the sperm sample composition after it has gone through the resting step e) to create a frozen sperm sample composition; and
g) thawing the sperm sample composition.

47. The method of claim 27 further comprising the steps:
f) vitrifying the sperm sample composition after it has gone through the resting step e) to create a vitrified sperm sample composition; and
g) thawing the sperm sample composition.

48. The method of claim 32 wherein at least 58% of live sperm in the sample are X chromosome bearing

49. The method of claim 19 wherein the temperature is 39° C.

50. A sperm sample obtained by the method of claim 1.

51. A sperm sample obtained by the method of claim 22.

52. A sperm sample of claim 51 wherein at least 58% of live sperm in the sample are X chromosome bearing, and the sample contains no fluorescent substances.

53. A sperm sample obtained by the method of claim 27.

54. A sperm sample obtained by the method of claim 46.

55. A sperm sample of claim 54 wherein at least 58% of live sperm in the sample are X chromosome bearing, and the sample contains no fluorescent substances.
